(19) United States
(12) Patent Application Publication
(10) Pub. No.: US 2006/0001374 A1
(43) Pub. Date: Jan. 5, 2006

(54) Plasma display panel

(76) Inventor: Jung-Suk Song, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/156,367

(22) Filed: Jun. 17, 2005

(30) Foreign Application Priority Data
Jun. 18, 2004 (KR) 10-2004-0045389

(51) Int. Cl. H01J 17/49

(52) U.S. Cl. 313/582

(57) ABSTRACT

One embodiment of the invention provides a plasma display panel (PDP), which has a remarkably high transmittance of visible light and thus, high brightness, in which a stable and efficient discharge can be achieved at a low voltage driving, thereby allowing for low production costs, and which has an extended lifetime since a reduced number of ions collide with fluorescent materials by preventing ion sputtering. In one embodiment, the PDP includes: i) a front substrate and a rear substrate facing each other, ii) barrier ribs made of a dielectric material and arranged between the front substrate and the rear substrate to define discharge cells in which a discharge occurs, iii) first electrodes arranged in the barrier ribs to surround first corner portions of the discharge cells, iv) second electrodes arranged in the barrier ribs to surround second corner portions of the discharge cells, the second corner portions being diagonally opposite to the first corner portions surrounded by the first electrodes, and the second electrodes facing the first electrodes in the discharge cells and being separated from the first electrodes, v) fluorescent layers arranged in the discharge cells, and vi) a discharge gas provided in the discharge cells.

### BACKGROUND OF THE INVENTION

This application claims the benefit of Korean Patent Application No. 10-2004-0045389, filed on Jun. 18, 2004, in the Korean Intellectual Property Office, the disclosure of which is incorporated herein in its entirety by reference.

1. Field of the Invention

The present invention relates to a plasma display panel (PDP), and more particularly, to a PDP which has a remarkably high transmittance of visible light and thus, an enhanced brightness, in which a stable and efficient discharge can be achieved at a low voltage driving, thereby allowing for low production costs, and which has an extended lifetime since a reduced number of ions collide with fluorescent materials by preventing ion sputtering.

2. Description of the Related Technology

FIG. 1 is an exploded perspective view of a conventional alternating current, triode-type, surface discharge plasma display panel (PDP) 100. Referring to FIG. 1, the conventional PDP 100 comprises a front panel 110 and a rear panel 120. The front panel 110 comprises a front substrate 111, pairs of sustain electrodes 114 including Y electrodes 112 and X electrodes 113 on a rear surface 111a of the front substrate 111, a front dielectric layer 115 covering the sustain electrodes 114, and a protective layer 116 covering the front dielectric layer 115.

Each of the Y electrodes 112 includes a transparent electrode 112b and a bus electrode 112a, and each of the X electrodes 113 includes a transparent electrode 113b and a bus electrode 113a. The transparent electrodes 112b and 113b are formed of indium tin oxide (ITO) or the like. The bus electrodes 112a and 113a are formed of a highly conductive metal.

The rear panel 120 comprises a rear substrate 121, address electrodes 122 on a front surface of the rear substrate 121 intersecting the pairs of sustain electrodes 114, a rear dielectric layer 123 covering the address electrodes 122, barrier ribs 130 arranged on the rear dielectric layer 123 and dividing a discharge space into discharge cells 126, and fluorescent layers 125 arranged in the discharge cells 126.

In the conventional PDP 100, in addition to the pairs of the sustain electrodes 114 which generate a discharge, the front dielectric layer 115 and the protective layer 116 are formed on the rear surface 111a of the front substrate 111 through which visible light generated from the fluorescent layers 125 is transmitted. Thus, the brightness of the PDP 100 is reduced since the transmittance of visible light is remarkably low due to at least partial blocking of a visible light path by the sustain electrodes 114, the front dielectric layer 115 and the protective layer 116.

Further, the majority of the sustain electrodes 114 (i.e., the transparent electrodes 112b and 113b, excluding the bus electrodes 112a and 113a) are formed of ITO, which is highly resistive, in order to allow the generated visible light to be transmitted through the front substrate 111. However, the ITO electrodes have higher resistance than other metal electrodes.

Due to the use of the ITO electrodes, a driving voltage of the PDP 100 increases and a voltage drop occurs, and thus, images cannot be uniformly displayed.

Furthermore, in the conventional PDP 100, the pairs of sustain electrodes 114 are formed on the rear surface 111a of the front substrate 111, through which visible light is transmitted, and the discharge occurs behind the protective layer 116 and diffuses within the discharge cells 126. In other words, the discharge occurs only in a portion of the discharge cells 126 and a space in the discharge cells 126 cannot be efficiently utilized.

As a result, a driving voltage for discharging must be increased, and thus, the manufacturing costs of a driving circuit, which is the most expensive part of the PDP 100, are increased. Further, due to the concentration of the discharge in a limited space in the discharge cells 126, efficiency of the PDP 100 is reduced.

Furthermore, since the pairs of sustain electrodes 114 are formed on the rear surface 111a of the front substrate 111 and the discharge occurs behind the front dielectric layer 115 and diffuses toward the fluorescent layers 125, when the conventional PDP 100 is used for a long time, charged discharge gas induces ion sputtering of the fluorescent material in the fluorescent layers 125 due to the electric field, thereby resulting in permanent after-images, that is to say images shown due to permanent damages of the fluorescent layers 125.

### SUMMARY OF CERTAIN INVENTIVE ASPECTS

One aspect of the present invention provides a plasma display panel (PDP) having the following advantages.

In one embodiment, the transmittance of visible light emitted from fluorescent layer is increased, thereby increasing the brightness of the PDP.

In another embodiment, a discharge uniformly occurs in discharge corner portions of discharge cells and is concentrated in the centers of the discharge cells, thereby allowing for a stable and efficient discharge at a low-voltage driving. As a result, the manufacturing costs of integrated circuit chips driving the PDP are reduced and thus, the overall production costs of the PDP are decreased.

In another embodiment, the use of ITO electrodes is excluded, and thus, the production costs of the PDP are reduced and a screen area of the PDP is increased.

In another embodiment, an acceleration path of ion particles is changed from the discharge corner portions of the discharge cells to the centers of the discharge cells and the number of the ions colliding with fluorescent materials is reduced, thereby preventing ion sputtering, and thus extending the lifetime of the PDP.

Another aspect of the present invention provides a PDP comprising: a front substrate and a rear substrate facing each other; barrier ribs made of a dielectric material and arranged between the front substrate and the rear substrate to define discharge cells in which a discharge occurs; first electrodes arranged in the barrier ribs to surround first corner portions of the discharge cells; second electrodes arranged in the barrier ribs to surround second corner portions of the discharge cells, the second corner portions being diagonally opposite to the first corner portions surrounded by the first electrodes, and the second electrodes facing the first electrodes in the discharge cells and being separated from the first electrodes; fluorescent layers arranged in the discharge cells; and a discharge gas provided in the discharge cells.

In one embodiment, the first electrodes may extend in the same direction as the discharge cells and the second electrodes may extend parallel to the direction in which the first electrodes extend.

In this embodiment, the first electrodes may have first electrode protruding portions which protrude to cross the direction in which the first electrodes extend such that the first electrodes surround the first corner portions of the discharge cells. Furthermore, the second electrodes may have second electrode protruding portions which protrude to cross the direction in which the second electrodes extend and face the first electrode protruding portions in the discharge cells such that the second electrodes surround the second corner portions of the discharge cells.

In one embodiment, the PDP may further comprise address electrodes crossing the direction in which the first electrodes and the second electrodes extend.

In one embodiment, the address electrodes may be arranged on the rear substrate and a dielectric layer may be arranged on the rear substrate to cover the address electrodes. The fluorescent layers may be arranged in spaces defined by the dielectric layer and the barrier ribs.

In one embodiment, the first electrodes may extend in the same direction as the discharge cells and the second electrodes may extend to cross the direction in which the first electrodes extend.

In this embodiment, the first electrodes may have first electrode protruding portions which protrude parallel to the direction in which the second electrodes extend in the discharge cells such that the first electrodes surround the first corner portions of the discharge cells. Furthermore, the second electrodes may have second electrode protruding portions which protrude parallel to the direction in which the first electrodes extend in the discharge cells and face the first electrode protruding portions in the discharge cells such that the second electrodes surround the second corner portions of the discharge cells.

In one embodiment, the PDP may further comprise protective layers arranged on at least portions of the barrier ribs.

In one embodiment, the barrier ribs may comprise central barrier rib portions and side barrier rib portions and the first electrodes and the second electrodes may be arranged on sidewalls of the central barrier rib portions and contacted by the side barrier rib portions.

In this embodiment, a dielectric material of the central barrier rib portions may have a lower dielectric constant than a dielectric material of the side barrier rib portions.

In one embodiment, the barrier ribs may comprise front barrier ribs and rear barrier ribs and the first electrodes and the second electrodes may be arranged in the front barrier ribs.

In this embodiment, the fluorescent layers may be arranged in spaces defined by the rear barrier ribs and the rear substrate.

### BRIEF DESCRIPTION OF THE DRAWINGS

The above and other features and advantages of embodiments of the present invention will be described with reference to the attached drawings.

FIG. 1 is an exploded perspective view of a conventional alternating current, triode-type, surface discharge plasma display panel (PDP).

FIG. 2 is an exploded perspective view of a PDP according to an embodiment of the present invention.

FIG. 3 is a plan view taken along line III-III of the PDP illustrated in FIG. 2, showing the positions of first electrodes, second electrodes, address electrodes, and discharge cells.

FIG. 4 is a perspective view of first electrodes, second electrodes, and address electrodes of the PDP illustrated in FIG. 2.

FIG. 5 is a cross-sectional view taken along line V-V of the PDP illustrated in FIG. 2, showing an address electrode.

FIGS. 6 through 8 are plan views illustrating the operation of the PDP illustrated in FIG. 2.

FIG. 9 is an exploded perspective view of a PDP according to another embodiment of the present invention.

FIG. 10 is a plan view taken along line X-X of the PDP illustrated in FIG. 9, showing the positions of first electrodes, second electrodes, and discharge cells.

FIG. 11 is a perspective view of first electrodes and second electrodes of the PDP illustrated in FIG. 9.

FIG. 12 is an exploded perspective view of a PDP according to still another embodiment of the present invention.

FIG. 13 is an exploded perspective view of a PDP according to yet another embodiment of the present invention.

### DETAILED DESCRIPTION OF CERTAIN INVENTIVE EMBODIMENTS

Hereinafter, a plasma display panel (PDP) according to embodiments of the present invention will be described by examples with reference to the attached drawings.

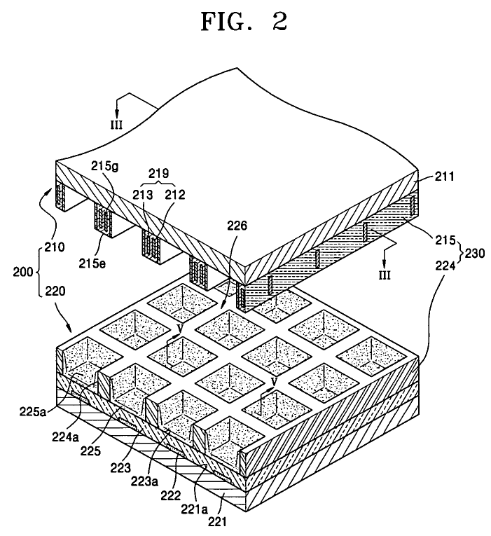

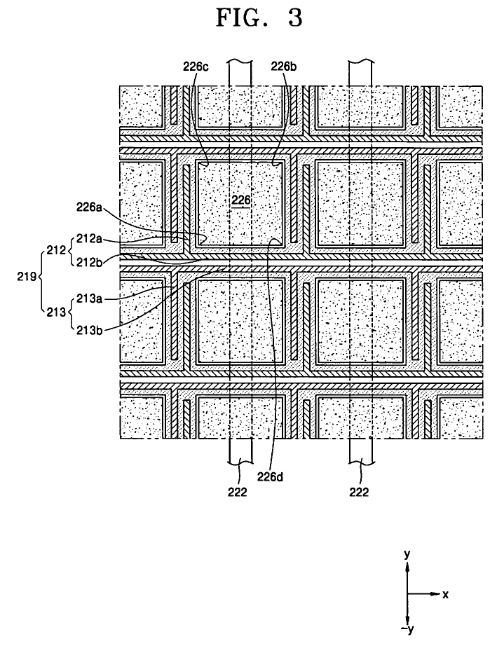

FIG. 2 is an exploded perspective view of a PDP 200 according to an embodiment of the present invention. FIG. 3 is a plan view taken along line III-III of the PDP 200 illustrated in FIG. 2. Referring to FIGS. 2 and 3, the PDP 200 comprises a front panel 210 and a rear panel 220. The front panel 210 comprises a front substrate 211, and the rear panel 220 comprises a rear substrate 221.

Barrier ribs 230 are arranged between the front panel 210 and the rear panel 220 to define discharge cells 226 in which a discharge occurs to generate light for displaying images. In one embodiment, the discharge cells 226 comprise first corner portions 226b, second corner portions 226a diagonally opposite to the first corner portions 226b, and discharge corner portions 226c and 226d. In one embodiment, the barrier ribs 230 may comprise front barrier ribs 215 and rear barrier ribs 224 which may be formed separately during the manufacturing process.

The front barrier ribs 215 are arranged on a rear surface of the front substrate 211 to define the discharge cells 226 together with the front substrate 211 and the rear substrate 221. The front panel 210 comprises discharge electrodes 219 which comprise first electrodes 213 and second electrodes 212. In one embodiment, the first electrodes 213 are arranged in the barrier ribs 230 such that they surround the first corner portions 226b of the discharge cells 226. In one embodiment, the second electrodes 212 are arranged in the barrier ribs 230 such that they surround the second corner portions 226a of the discharge cells 226, the second corner portions 226a being diagonally opposite to the first corner portions 226b surrounded by the first electrodes 213, the second electrodes 212 facing the first electrodes 213 in the discharge cells 226 and separated from the first electrodes 213.

Referring to FIG. 3, the first electrodes 213 extend in a predetermined direction and more specifically, in the x-axis direction, and the second electrodes 212 extend in the x-axis direction to be parallel to the direction in which the first electrodes 213 extend.

In one embodiment, the first electrodes 213 comprise first electrode protruding portions 213a and first electrode extending portions 213b. The first electrode protruding portions 213a protrude to cross the direction in which the first electrodes 213 extend, i.e., protrude in the −y-axis direction of FIG. 3, such that the first electrodes 213 surround the first corner portions 226b of the discharge cells 226. The second electrodes 212 may comprise second electrode protruding portions 212a and second electrode extending portions 212b. The second electrode protruding portions 212a protrude to cross the direction in which the second electrodes 212 extend, i.e., protrude in the y-axis direction of FIG. 3, and face the first electrode protruding portions 213a in the discharge cells 226 such that the second electrodes 212 surround the second corner portions 226a of the discharge cells 226, the second corner portions 226a being diagonally opposite to the first corner portions 226b surrounded by the first electrodes 213.

The front panel 210 may comprise protective layers 216 covering outer sidewalls 215g of the front barrier ribs 215, if necessary. The protective layers 216 may be formed on the rear surface of the front substrate 211 or front surfaces 225a of fluorescent layers 225, in addition to the outer sidewalls 215g of the front barrier ribs 215.

In one embodiment, the rear panel 220 comprises address electrodes 222 arranged on a front surface 221a of the rear substrate 221 and extending to cross the discharge electrodes 219, and more specifically, extending in the y-axis direction to cross the discharge cells 226. The rear panel 220 may comprise a dielectric layer 223 covering the address electrodes 222. The rear panel 220 comprises the rear barrier ribs 224 formed on the dielectric layer 223 and the fluorescent layers 225 arranged in spaces defined by the rear barrier ribs 224. Since the fluorescent layers 225 are arranged to cover the address electrodes 222, the dielectric layer 223 can be omitted. However, in order to prevent the address electrodes 222 from being damaged during the formation of the barrier ribs 230 or to perform an efficient address discharge, for example, by increasing the amount of wall charges accumulated during the address discharge, in one embodiment, the rear panel 220 comprises the dielectric layer 223.

In one embodiment, the front panel 210 and the rear panel 220 may be combined with each other using a combination member, such as a frit (not shown) and sealed. Alternatively, when a discharge gas in the discharge cells 226 is in a vacuum state, the front panel 210 and the rear panel 220 are pressed against each other by the pressure due to the vacuum state, thereby reinforcing the combination thereof.

The discharge cells 226 are filled with a discharge gas, such as neon (Ne), helium (He), argon (Ar), each containing xenon (Xe) gas, or a mixture thereof.

In one embodiment, the front substrate 211 and the rear substrate 221 are generally made of glass. In another embodiment, the front substrate 211 may be made of a material having a high light transmittance. In still another embodiment, the rear substrate 221 is made of a transparent material since the rear substrate 221 is not in an optical path of the visible light.

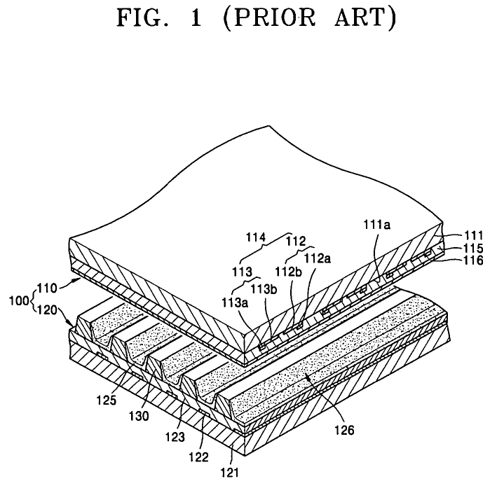

In one embodiment, the PDP 200 does not include elements of the conventional PDP 100 illustrated in FIG. 1 such as the sustain electrodes 114 on the rear surface of the front substrate 111, the front dielectric layer 115 covering the sustain electrodes 114, and the protective layer 116 covering the front dielectric layer 115, in a portion of the rear surface of the front substrate 211, which defines the discharge cells 226. Thus, when considering only the PDP 200, excluding, for example, a filter arranged in the front of the PDP 200, the visible light generated by the fluorescent layers 225 is transmitted only through the transparent front substrate 211, which has a high light transmittance, thereby greatly increasing the transmittance of the visible light, compared to the conventional PDP 100.

In one embodiment, in order to increase the brightness of the PDP 200, a reflective layer (not shown) may be arranged on the front surface 221a of the rear substrate 221 or the front surface 223a of the dielectric layer 223, or a light reflective material may be contained in the dielectric layer 223 such that the visible light generated by the fluorescent layers 225 is efficiently reflected forward.

In the conventional alternating current, triode-type, surface discharge PDP 100, in order to increase the transmittance of visible light, the first electrodes 213 and the second electrodes 212 are made of ITO, which has a relatively high resistance. However, in one embodiment as illustrated in FIG. 2, the first electrodes 213 and the second electrodes 212 can be made of a material having any level of transmittance of visible light.

In one embodiment, the first electrodes 213 and the second electrodes 212 can be made of materials which are inexpensive and have high electrical conductivity, such as Ag, Cu, Cr, etc. Therefore, in this embodiment, the problems that appear in the conventional PDP 100, i.e., the increase in a driving voltage by ITO sustain electrodes and the impossibility to display uniform images due to the voltage drop in the ITO electrodes when the conventional PDP 100 is large, can be overcome and the production costs of the PDP 200 can be reduced.

The barrier ribs 230 are arranged between the front substrate 211 and the rear substrate 221 to define the discharge cells 226 together with the front substrate 211 and the rear substrate 221. In one embodiment, the discharge cells 226 are defined into a matrix shape by the barrier ribs 230 in FIG. 2, but are not limited thereto, and may have various shapes, for example, a honeycomb or delta shape.

In one embodiment, the cross-sections of the discharge cells 226 are rectangular in FIG. 2, but are not limited thereto. In another embodiment, the discharge cells 226 may have smoothly curved surfaces. In another embodiment, especially, after a baking process for forming the barrier ribs 230, the cross-sections of the discharge cells 226 are oval, rather than rectangular, since the discharge cells 226 shrink due to the baking.

In still another embodiment, the cross-sections of the discharge cells 226 may be polygonal, for example, triangles or pentagons, or circular, oval, etc.

For example, when a cross-section of each of the discharge cells 226 is circular or oval, a region near a point on a circumference of a portion of the discharge cell 226 which is divided by an imaginary surface cutting the discharge cell 226 in a direction perpendicular to the cross-section of the discharge cell 226 may be set to a first corner portion. Also, a region near a point opposite to the above point and present on a circumference of the other portion of the discharge cell 226 may be a second corner portion.

In one embodiment, the first electrodes 213 and the second electrodes 212 can be arranged to surround the first corner portions 226b and the second corner portions 226a of the discharge cells 226, respectively, although the discharge cells 226 have any shape, for example, circular or oval. Thus, although the terms “corner portions” of the discharge cells 226 and “diagonally” are used on the assumption that the cross-sections of the discharge cells 226 are polygonal, the shapes of the cross-sections of the discharge cells 226 may have other forms according to an embodiment of the present invention. In such a situation, the first and second electrodes 213, 212 may surround at least in part the first portions 226b and the second portions 226a of the discharge cells 226, respectively.

The discharge electrodes 219 are arranged in the front barrier ribs 215 and the discharge occurs by applying a potential between the discharge electrodes 219. In one embodiment, the front barrier ribs 215 should be made of a dielectric material such that an electric field occurring due to the potential applied between the discharge electrodes 219 generated inside the discharge cells 226 by the molecule arrangement of the material of the front barrier ribs 215.

In another embodiment, the front barrier ribs 215 may be made of a dielectric material, such as glass containing elements such as Pb, B, Si, Al, and O, and if necessary, a filler such as ZrO₂, TiO₂, and Al₂O₃ and a pigment such as Cr, Cu, Co, Fe, TiO₂. Such a dielectric material induces charged particles due to the potential applied between the discharge electrodes 219, and thus, induces the wall charges which participate in the discharge and protect the discharge electrodes 219.

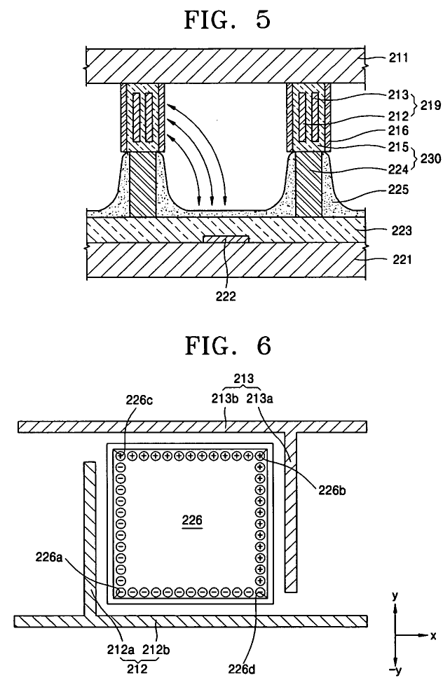

In one embodiment, after the front barrier ribs 215 are formed, the protective layers 216 (see FIG. 5) may be formed on the outer sidewalls 215g of the front barrier ribs 215 by deposition, etc. The protective layers 216 can protect the first electrodes 213, the second electrodes 212, and the dielectric layer 223 covering the second electrodes 212, and emit secondary electrons during the discharge, thereby allowing the discharge to be easily generated.

In one embodiment, during the formation of the protective layers 216, a protective layer may be further formed on the rear surface of the front substrate 211 and on the rear surfaces 215e of the front barrier ribs 215. The protective layer thus formed does not have an adverse effect on the PDP of the present invention.

The rear barrier ribs 224 may be formed on the dielectric layer 223. In one embodiment, the rear barrier ribs 224 may be made of a dielectric material, such as glass containing elements such as Pb, B, Si, Al, and O, and if necessary, a filler such as ZrO₂, TiO₂, and Al₂O₃ and a pigment such as Cr, Cu, Co, Fe, TiO₂, as in the front barrier ribs 215.

The rear barrier ribs 224 define spaces on which the fluorescent layers 225 are coated and, together with the front barrier ribs 215, resist the vacuum pressure (for example, 0.5 atm) of the discharge gas filled between the front panel 210 and the rear panel 220. The rear barrier ribs 224 also define spaces for the discharge cells 226 and prevent cross-talk between the discharge cells 226. In one embodiment, the rear barrier ribs 224 may contain a reflective material to reflect the visible light generated in the discharge cells 226 forward.

The fluorescent layers 225, which emit red, green, or blue light, may be arranged in the spaces defined by the rear barrier ribs 224. The fluorescent layers 225 are divided by the rear barrier ribs 224.

The fluorescent layers 225 are formed by coating a fluorescent paste comprising either red, green, or blue light-emitting fluorescent material, a solvent, and a binder, on the front surface 223a of the dielectric layer 223 and the outer sidewalls 224a of the rear barrier ribs 224, and drying and baking the resultant structure.

In one embodiment, the red light-emitting fluorescent material may be Y(V,P)O4:Eu, etc., the green light-emitting fluorescent material may be ZnSiO₄:Mn, YBO₃:Tb, etc., and the blue light-emitting fluorescent material may be BAM:Eu, etc.

In one embodiment, the rear protective layers (now shown), made of, for example, MgO, may be formed on the front surfaces 225a of the fluorescent layers 225. When the discharge occurs in the discharge cells 226, the rear protective layers can prevent deterioration of the fluorescent layers 225 due to collisions of the discharge particles and emit secondary electrons, thereby allowing the discharge to be easily generated. However, the presence of the rear protective layers is not always advantageous. When the rear protective layers are too thick, the transmittance of UV light can be reduced.

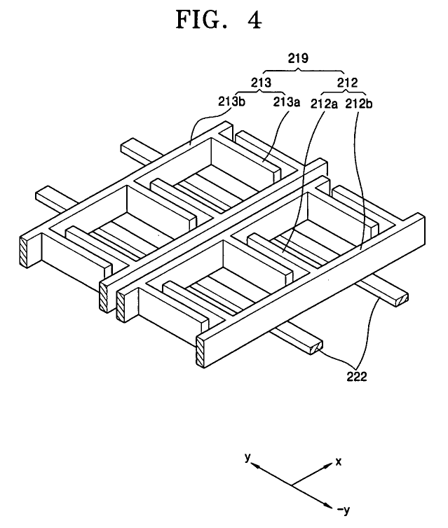

FIG. 4 is a perspective view of first electrodes 213, second electrodes 212, and address electrodes 222 of the PDP 200 illustrated in FIG. 2.

Referring to FIG. 4, the first electrodes 213 extend in the x-axis direction, and the second electrodes 212 extend in the x-axis direction to be parallel to the direction in which the first electrodes 213 extend.

As described above, the first electrodes 213 comprise first electrode protruding portions 213a which protrude in the −y-axis direction. The second electrodes 212 may comprise second electrode protruding portions 212a which protrude in the −y-axis direction and face the first electrode protruding portions 213a in the discharge cells 226.

The operation of the PDP 200 illustrated in FIG. 2 will now be explained briefly referring to FIGS. 5 through 8. A driving mode of the PDP 200 is explained on the basis of a particular driving mode, but is not limited thereto. The PDP 200 can be driven according to various driving modes. The following driving mode is only an example to illustrate the concept of the present invention.

An address discharge according to an embodiment of the present invention will now be described with reference to FIG. 5.

In general, the term “address discharge” refers to a discharge for selecting a discharge cell in which a sustain discharge will occur (a sustain discharge will be explained later). The address discharge occurs by applying a pulse potential between a pair of electrodes which cross at a discharge cell where the sustain discharge will occur, to generate a discharge and making wall charges induced by the discharge accumulate on inner surfaces of the discharge cell.

Since the electrodes 219 including the first electrodes 213 and the second electrodes 212 are arranged to cross the address electrodes 222, such an address discharge can occur between the first electrodes 213 and the address electrodes 222 or between the second electrodes 212 and the address electrodes 222. Herein, it is assumed that the address discharge occurs between the second electrodes 212 and the address electrodes 222.

When a predetermined pulse potential is applied between the address electrodes 222 and the second electrodes 212 from an external power supply, one of the discharge cells 226 to be lighted, at which the second electrodes 212 and the address electrodes 222 cross, is selected. Then, when the potential difference generated due to the pulse potential applied between the second electrodes 212 and the address electrodes 222 reaches a firing voltage, a discharge occurs in the selected discharge cell 226. Due to the discharge, wall charges are accumulated on the inner surfaces of the selected discharge cell 226.

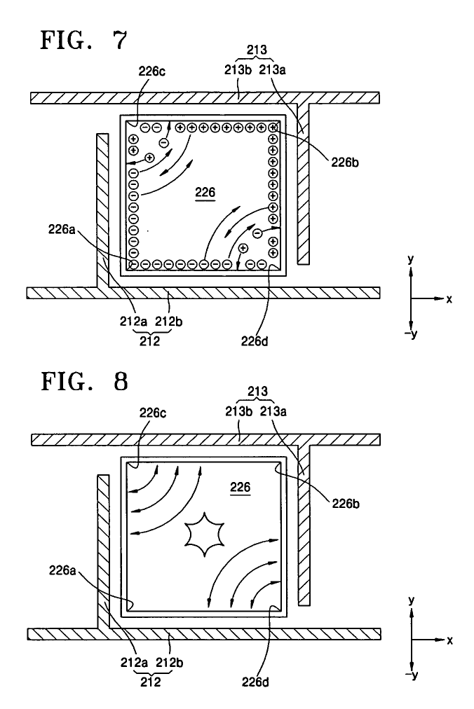

A sustain discharge of the PDP 200 illustrated in FIG. 2 will now be described with reference to FIGS. 6 through 8. In general, the term “sustain discharge” refers to a discharge for generating a gray scale corresponding to an external image signal in the discharge cell selected by the address discharge.

To display a specific gray scale by a sustain discharge, potentials are alternately applied between a pair of the sustain electrodes for a specific number of times. At this time, since the wall charges are accumulated only in the discharge cell selected by the address discharge, a potential applied by the pair of the sustain electrodes interacts with the wall charges, thereby generating the discharge in the selected discharge cell. Such a discharge is repeated a predetermined number of times corresponding to external image signals and thus, the gray scale is displayed. Such a sustain discharge substantially displays an image on the panel and the characteristics of the sustain discharge determines the discharge amount and brightness of the PDP.

Referring to FIG. 6, wall charges are accumulated on inner sidewalls of a discharge cell 226 due to an address discharge. Specifically, positive wall charges are accumulated on inner sidewalls of the discharge cell 226 in which a first electrode 213 is arranged and negative wall charges are accumulated on inner sidewalls of the discharge cell 226 in which a second electrode 212 is arranged. At this time, a negative potential is applied to the first electrode 213 and a positive potential is applied to the second electrode 212.

Then, referring to FIG. 7, as a positive potential is applied to the first electrode 213 and a negative potential is applied to the second electrode 212, a predetermined potential difference is generated, and thus, a dielectric material of a barrier rib 230 is polarized. As a result, an electric field is formed in the discharge cell 226.

At this time, according to Gauss' law, since an equipotential surface is formed on a surface of a conductive material when an identical potential is applied to the conductive material, an equipotential surface corresponding to the potential applied to the first electrode 213 is formed on the entire surface of the first electrode 213 and an equipotential surface corresponding to the potential applied to the second electrode 212 is formed on the entire surface of the second electrode 212.

In one embodiment, the first electrode 213 is arranged to surround a first corner portion 226b of the discharge cell 226 and the second electrode 212 is arranged to surround a second corner portion 226a of the discharge cell 226, the second corner portion 226a being diagonally opposite to the first corner portion 226b. Due to the equipotential on the surface of the first electrode 213, a strength of the electric field around the first corner portion 226b of the discharge cell 226 surrounded by the first electrode 213 is constant, i.e., a strength of electric field generated on surfaces which form the first corner portion 226b is constant. Likely, the strength of an electric field generated on surfaces which form the second corner portion 226a is constant.

In corner portions 226c and 226d other than the first corner portion 226b and the second corner portion 226a (hereinafter, referred to as discharge corner portions) of the discharge cell 226, a strong electric field is generated in a direction from the first electrode 213 to the second electrode 212 due to the potential difference generated according to the potential applied between the first electrode 213 and the second electrode 212.

The strength of the electric field at a predetermined position is decreased as the position is closer to the center of the discharge cell 226 apart from the discharge corner portions 226c and 226d. This can be easily confirmed from the physical rule that the strength of an electric field is proportional to a potential difference and inversely proportional to the distance between points to which the potential is applied.

Thus, the wall charges accumulated on the discharge corner portions 226c and 226d due to the strong electric field generated on the discharge corner portions 226c and 226d move in the direction of the electric field. Thus, the wall charges collide with discharge gas atoms and, as illustrated in FIG. 7, such a collision diffuses toward the center of the discharge cell 226, while exciting the discharge gas in the discharge cell 226 from a low energy level to a high energy level.

Then, while the energy level of the excited discharge gas is lowered from the high energy level to the low energy level, ultraviolet (UV) light having a predetermined wavelength is generated. The UV light excites a fluorescent layer 225 arranged in the discharge cell 226, more specifically in a space defined by a rear barrier ribs 224 and a dielectric layer 223. Then, while the energy level of the fluorescent layer 225 is changed from high to low, visible light is generated.

Unlike the conventional alternating current, triode-type, surface discharge PDP 100, the PDP 200 comprises the discharge electrode 219 arranged in the barrier rib 230, and the discharge diffuses from the discharge corner portions 226c and 226d to the center of the discharge cell 226. Thus, a probability that the discharge occurs and the discharge amount are remarkably increased, compared to the conventional PDP 100 in which the discharge occurs on only a rear surface of the front substrate.

As described above, the discharge initiates in the discharge corner portions 226c and 226d and diffuses toward the center of the discharge cell 226 and the wall charges move between both inner sidewalls, which form each of the discharge corner portions 226c and 226d of the discharge cell 226. Thus, a likelihood that the wall charges collide with the fluorescent layer 225 coated on the dielectric layer 223 is greatly reduced.

This implies that a likelihood that ion particles in the discharge cell 226 collide with the fluorescent layer 225 is greatly reduced. As a result, ion collision with the fluorescent layer 225 is inhibited and thus, ion sputtering is basically prevented.

When the potential difference between the first electrode 213 and the second electrode 212 becomes lower than the firing voltage after the discharge, the discharge is no longer generated, and space charges and wall charges accumulate in the discharge cell 226. At this time, when a pulse potential of the opposite polarity is applied between the first electrode 213 and the second electrode 212, the potential difference reaches the firing voltage with the aid of the wall charges and a discharge is generated again.

When the polarity of the pulse potential applied between the first electrode 213 and the second electrode 212 is repeatedly and alternately changed, the discharge is maintained. Due to the potential alternately applied between the first electrode 213 and the second electrode 212, UV light is generated from the fluorescent layer 225 in the same number of times as the discharge occurs, thereby displaying a predetermined gray scale on the PDP. As a result, the PDP 200 can display a desired image by such a sustain discharge.

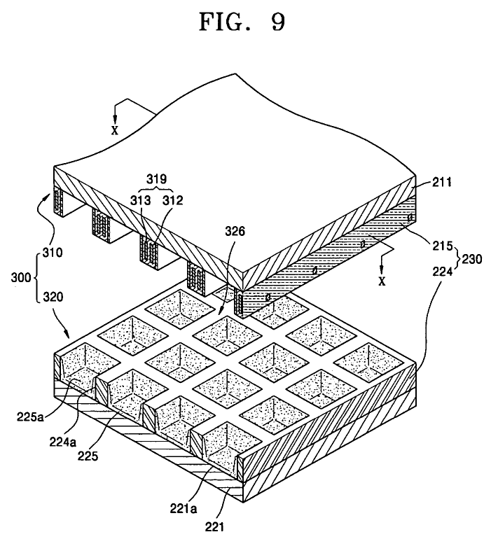

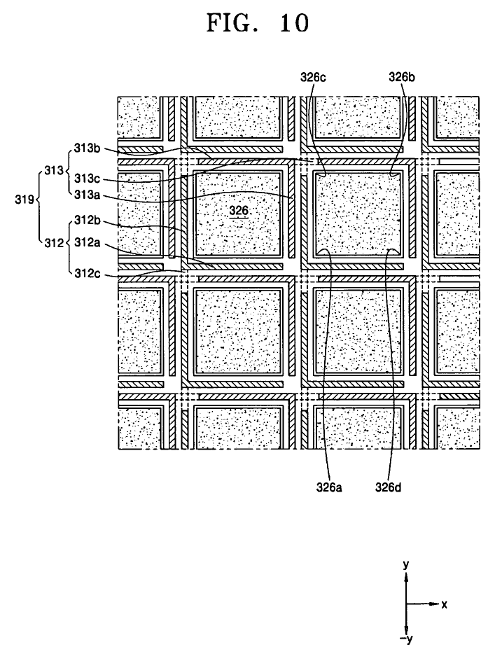

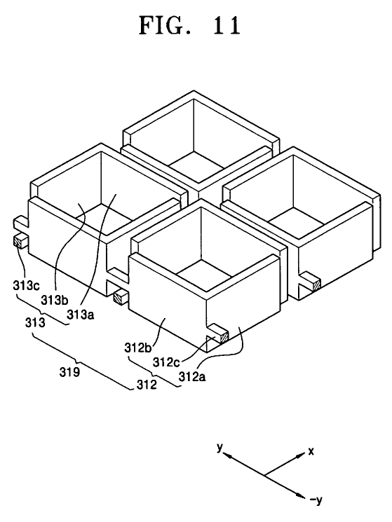

FIG. 9 is an exploded perspective view of a PDP 300 according to another embodiment of the present invention. FIG. 10 is a plan view taken along line X-X of the PDP 300 illustrated in FIG. 9, showing the locations of first electrodes 313, second electrodes 312, and discharge cells 326. FIG. 11 is a perspective view of first electrodes 313 and second electrodes 312 of the PDP 300 illustrated in FIG. 9. Referring to FIGS. 9 through 11, the PDP 300 will be explained based on the differences from the PDP 200 illustrated in FIG. 2.

Referring to FIGS. 9 through 11, the PDP 300 does not comprise address electrodes 222 which are present in the PDP 200 illustrated in FIG. 2. The first electrodes 313 are electrically connected to first electrode connective portions 313c and extend in a direction in which the discharge cells 326 extend, more specifically in the x-axis direction. The second electrodes 312 are electrically connected to second electrode connective portions 312c and extend to cross the direction in which the first electrodes 313 extend, more specifically extend in the −y-axis direction.

In one embodiment, since the first electrodes 313 and the second electrodes 312 cross at the discharge cells 326, a potential applied between the first electrodes 313 and the second electrodes 312 can be controlled to allow an address discharge to occur in one of the discharge cells 326. Thus, a separate address electrode is not required.

In this embodiment, a separate process of disposing the address electrodes is not required and also a driver integrated circuit chip for controlling the potential applied to the address electrodes is not required. As a result, the production costs of the PDP 300 are greatly reduced.

Additionally, since the address electrodes are not formed, a dielectric layer for covering the address electrodes is not required any more in the PDP 300, and thus, the production costs of the PDP 300 can be further reduced. As in the PDP 200 illustrated in FIG. 2, the first electrodes 313 may be arranged in front barrier ribs 215 such that they surround first corner portions 326b of the discharge cells 326. Also, the second electrodes 312 may be arranged in the front barrier ribs 215 such that they surround second corner portions 326a of the discharge cells 326.

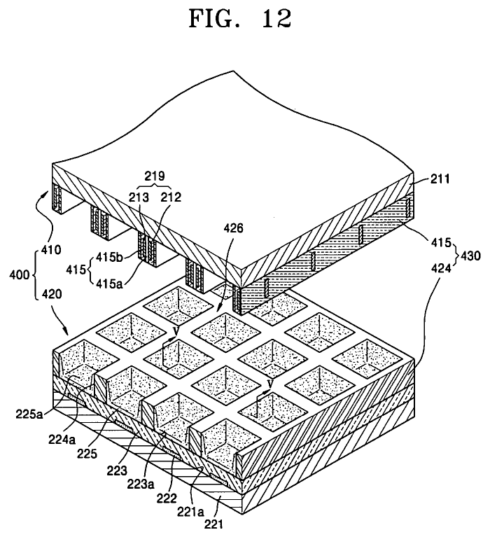

FIG. 12 is an exploded perspective view of a PDP 400 according to still another embodiment of the present invention. Referring to FIG. 12, the PDP 400 will be explained based on the differences from the PDP 200 illustrated in FIG. 2. The PDP 400 differs from the PDP 200 illustrated in FIG. 2 in the location of front barrier ribs 415.

In one embodiment, the front barrier ribs 415 comprise central barrier rib portions 415a and side barrier rib portions 415b in order to prevent a misdischarge between discharge cells 426 due to the interference between first electrodes 413 and second electrodes 412 which can occur according to operation modes of the PDP 400. Thus, the manufacturing process of the barrier ribs 415 is simplified.

In one embodiment, the central barrier rib portions 415a may be made of a material having a lower relative dielectric constant than a material of the side barrier rib portions 415b, in order to prevent the interference between the discharge cells 426 which can occur according to the operation modes of the PDP 400.

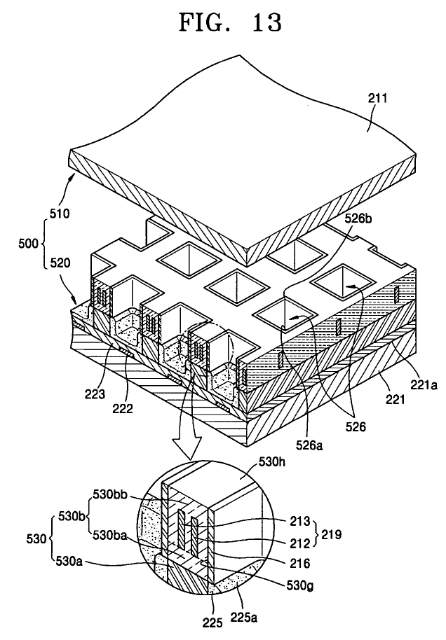

FIG. 13 is an exploded perspective view of a PDP 500 according to yet another embodiment of the present invention. The PDP 500 differs from the PDP 200 illustrated in FIG. 2 in that integrated barrier ribs 530 in the PDP 500 replace the front barrier ribs 215 and the rear barrier ribs 224 in the PDP 200.

In one embodiment, the integration of the front barrier ribs 215 and the rear barrier ribs 224 into the integrated barrier ribs 530 means that front barrier ribs 215 and the rear barrier ribs 224 are joined and cannot be separated without breaking, but does not mean that the barrier ribs 530 are produced in one process. The basic characteristics of the integrated barrier ribs 530 in the PDP 500 are the same as in the PDP 200, for example, the barrier ribs 530 define discharge cells 526 and resist a pressure applied by the discharge gas in a vacuum state.

Referring to the enlarged view shown in FIG. 13, the manufacturing process of an integrated barrier rib 530 will be now briefly explained.

First, a rear portion 530a of the barrier rib 530 is formed on a front surface 221a of a rear substrate 222. Then, a space defined by the rear portion 530a is filled with a paste comprising a fluorescent material and the paste is dried and baked. Next, a first barrier rib layer 530ba is formed on the rear portion 530a of the integrated barrier rib 530, and a first electrode 213 and a second electrode 212 are formed on the first barrier rib layer 530ba. Then, a second barrier rib layer 530bb is formed to cover the first electrode 213 and the second electrode 212 to obtain a front portion 530b of the barrier rib 530. The rear portion 530a, the first barrier rib layer 530ba, and the second barrier rib layer 530bb may each comprise more than two layers, if necessary, to increase their thicknesses.

After forming the integrated barrier rib 530, protective layers 216 are formed on at least sidewalls 530g of the front portion 530a of the integrated barrier rib 530, using deposition. In one embodiment, during the deposition of the protective layers 216, rear protective layers (not shown) may also be formed on front surfaces 225a of fluorescent layers 225. The function of the protective layers 216 is as described above.

In one embodiment, during the deposition of the protective layers 216, a protective layer may be further formed on a front surface 530h of the integrated barrier rib 530. The protective layer formed on the front surface 530h does not have a great adverse effect on the operation of the PDP 500.

The PDP according to embodiments of the present invention has the following effects.

First, the PDP has a structure in which discharge electrodes are arranged in barrier ribs surrounding discharge cells, unlike a conventional PDP in which pairs of sustain electrodes are arranged in a front panel. Thus, there is no need for a dielectric layer or a protective layer, etc., on the front panel through which visible light is transmitted. As a result, the PDP allows the visible light generated by fluorescent layers in the discharge cells to pass directly through a front substrate, thereby greatly increasing light transmittance.

Second, in the conventional PDP, the sustain electrodes which generate the discharge are arranged on the rear surface of the front substrate, and in order to allow the visible light generated by the fluorescent layers in the discharge cells to be transmitted through the front substrate, the majority of the sustain electrodes must be formed of ITO, which is very expensive and highly resistive. Thus, the driving voltage is increased and the production costs of the conventional PDP are high. Further, since the high resistance of the ITO electrodes causes a voltage drop, images cannot be uniformly realized when the conventional PDP is large. However, in the PDP according to one embodiment of the present invention, the discharge electrodes are arranged in the barrier ribs, and thus, the discharge electrodes can be formed of a highly conductive, inexpensive material.

Third, in the conventional PDP, the sustain electrodes are formed on the rear surface of the front substrate, and the discharge occurs behind the protective layer in the discharge cells and diffuses within the discharge cells. Thus, the luminous efficiency of the conventional PDP is reduced. When the conventional PDP is used for a long time, a charged discharge gas induces ion sputtering of the fluorescent material due to the electric field, thereby resulting in permanent after-images. However, in the PDP according to one embodiment the present invention, the discharge occurs in discharge corner portions of the discharge cells and diffuses to concentrate on the centers of the discharge cells, increasing the discharge efficiency. The wall charges move between both inner sidewalls which form each of the discharge corner portions of the discharge cells, and thus, the amount of ion particles that collide with fluorescent layers is remarkably reduced. As a result, ion sputtering of the fluorescent material is prevented, thereby extending the lifetime of the PDP and preventing the permanent after-images which lower the image quality.

Fourth, in the PDP according to one embodiment of the present invention, first electrodes and second electrodes are arranged in the barrier ribs and the discharge stereoscopically occurs along the discharge corner portions of the discharge cells, and thus a discharge space is enlarged, thereby increasing the discharge efficiency. As a result, a driving voltage of the PDP can be reduced and a low voltage driving integrated circuit can be used, thereby reducing the production costs of the PDP.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A plasma display panel (PDP), comprising:
a front substrate and a rear substrate facing each other;
barrier ribs made of a dielectric material and arranged between the front substrate and the rear substrate to define discharge cells in which a discharge occurs;
first electrodes arranged in the barrier ribs to surround first corner portions of the discharge cells;
second electrodes arranged in the barrier ribs to surround second corner portions of the discharge cells, the second corner portions being diagonally opposite to the first corner portions surrounded by the first electrodes, and the second electrodes facing the first electrodes in the discharge cells and being separated from the first electrodes;
fluorescent layers arranged in the discharge cells; and
a discharge gas provided in the discharge cells.

2. The PDP of claim 1, wherein the first electrodes extend in the same direction as the discharge cells and the second electrodes extend parallel to the direction in which the first electrodes extend.

3. The PDP of claim 2, wherein the first electrodes have first electrode protruding portions which protrude to cross the direction in which the first electrodes extend such that the first electrodes surround the first corner portions of the discharge cells.

4. The PDP of claim 3, wherein the second electrodes have second electrode protruding portions which protrude to cross the direction in which the second electrodes extend and face the first electrode protruding portions in the discharge cells such that the second electrodes surround the second corner portions of the discharge cells.

5. The PDP of claim 2, further comprising address electrodes crossing the direction in which the first electrodes and the second electrodes extend.

6. The PDP of claim 5, wherein the address electrodes are arranged on the rear substrate and a dielectric layer is arranged on the rear substrate to cover the address electrodes.

7. The PDP of claim 6, wherein the fluorescent layers are arranged in spaces defined by the dielectric layer and the barrier ribs.

8. The PDP of claim 1, wherein the first electrodes extend in the same direction as the discharge cells and the second electrodes extend to cross the direction in which the first electrodes extend.

9. The PDP of claim 8, wherein the first electrodes have first electrode protruding portions which protrude parallel to the direction in which the second electrodes extend in the discharge cells such that the first electrodes surround the first corner portions of the discharge cells.

10. The PDP of claim 9, wherein the second electrodes have second electrode protruding portions which protrude parallel to the direction in which the first electrodes extend in the discharge cells and face the first electrode protruding portions in the discharge cells such that the second electrodes surround the second corner portions of the discharge cells.

11. The PDP of claim 1, further comprising protective layers arranged on at least portions of the barrier ribs.

12. The PDP of claim 1, wherein the barrier ribs comprise central barrier rib portions and side barrier rib portions, and wherein the first electrodes and the second electrodes are arranged on sidewalls of the central barrier rib portions and contacted by the side barrier rib portions.

13. The PDP of claim 12, wherein a dielectric material of the central barrier rib portions has a lower dielectric constant than a dielectric material of the side barrier rib portions.

14. The PDP of claim 1, wherein the barrier ribs comprise front barrier ribs and rear barrier ribs, and wherein the first electrodes and the second electrodes are arranged in the front barrier ribs.

15. The PDP of claim 14, wherein the fluorescent layers are arranged in spaces defined by the rear barrier ribs and the rear substrate.

16. A plasma display panel (PDP), comprising:
a plurality of barrier ribs configured to define a plurality of discharge cells;
a plurality of first discharge electrodes formed within the plurality of barrier ribs; and
a plurality of second discharge electrodes formed within plurality of barrier ribs,
wherein the plurality of barrier ribs have first and second portions opposing each other in a substantially diagonal arrangement, wherein each of the plurality of first discharge electrodes is integrated into the first portion, and wherein each of the plurality of second discharge electrodes is integrated into the second portion.
